(19) United States
(12) Patent Application Publication
(10) Pub. No.: US 2024/0086348 A1
(43) Pub. Date: Mar. 14, 2024

(54) CAPTURING TIMESTAMP-BASED DATA IN A DYNAMICALLY ALIGNED WINDOW

(71) Applicant: Blue Origin, LLC, Kent, WA (US)

(72) Inventor: Jin Zhang, Bothell, WA (US)

(21) Appl. No.: 17/932,007

(22) Filed: Sep. 14, 2022

(51) Int. Cl. G06F 13/24; G01C 21/16

(52) U.S. Cl. CPC G06F 13/24; G01C 21/16

(57) ABSTRACT

A method and system are described for data acquisition between or among two or more systems having individual clock domains, such as from a sensor system to a processor system, each system operating on its own clock domain. The sensor system, such as navigation sensors, generally output time information via various discrete signals that are generated by a clock of the sensor system. On the other hand, the processor system, such as an FPGA, may operate on a different clock. The FPGA may use predicted windows in which to monitor for the availability of sensor data, which will be timestamped for a navigation algorithm to subsequently use. Use of such predicted windows can filter unwanted data transactions, which may arise from various glitches or mis-timings between the two systems.

### BACKGROUND

Sensors, such as navigation sensors, generally output sensor data with time information that is generated by a clock that is different from a clock of a system that receives the sensor data. In other words, a sensor and receiving system may have different clock domains. For example, an inertial measurement unit (IMU) may have its own clock while a receiving processor system, such as a Field Programmable Gate Array (FPGA), operates on a different clock. Each clock (e.g., a timer circuit) generally has its own fixed frequency. Even if the frequencies of both clocks are designed to be the same, the cycle of one clock tends to drift relative to the other clock.

For successful data acquisition, a receiving system samples data from sensors within time windows that are fixed and a priori known. One way of doing this is for the receiving system to provide the sensors with timing information based on the clock of the receiving system. For example, via feedback, timing of the sensors may be synchronized with the timing of the receiving system. In sensor-receiving systems that lack sharing of timing information and have different clock domains, data acquisition may involve a number of problems, such as receiving data with incomplete or incorrect timestamps, as well as missing, noisy, or faulty data.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is a flow diagram illustrating a data acquisition process for a sensor-FPGA system having two clock domains, according to some embodiments.

FIG. 2 is a block diagram illustrating a data acquisition process for a sensor-FPGA system having a common clock domain, according to some embodiments.

FIG. 3 is a block diagram illustrating a data acquisition process for a sensor-FPGA system having two clock domains, according to some embodiments.

FIG. 4 is a block diagram of a sensor-processor system, according to some embodiments.

FIG. 5 is a timing diagram for data acquisition, according to some embodiments.

FIGS. 6-10 are timing diagrams for data acquisition involving various glitches, according to some embodiments.

FIG. 11 is a block diagram of a processor system, according to some embodiments.

### DETAILED DESCRIPTION

This disclosure describes techniques and architectures for data acquisition between or among two or more systems having individual clock domains, such as data acquisition from a sensor system to a processor system. Examples herein involve, specifically, a sensor system and a processor system, each system operating on its own clock domain. The sensor system, such as navigation sensors, generally output time information via various discrete signals that are generated by a clock of the sensor system. In this way, sensor measurement data can be timestamped. On the other hand, the processor system, such as an FPGA, may operate on a different clock. The FPGA may use predicted windows in which to monitor for the availability of sensor data, which will be timestamped for a navigation algorithm to subsequently use. Use of such predicted windows can filter unwanted data transactions (e.g., unwanted input), which may arise from various glitches or mis-timings between the two systems. For example, if the FPGA and sensor(s) operate by different clock domains, predicted windows for capturing discrete (time information) signals from the sensor(s) may drift relative to the timing of the sensor data and the discrete signals. Thus, eventually the sensor data outputs may drift out of the FPGA-defined predicted (e.g., data-capturing) windows. In an example embodiment herein, a dynamically synchronized prediction window is created to eliminate accumulated clock drift between a sensor clock domain and an FPGA clock domain. In this fashion, the FPGA system clock may be adaptive to the timing of the sensor clock(s) and their output. Additionally, some embodiments result in improved latency performance over state of the art techniques.

In a particular embodiment, an interface (e.g., an input/output interface) between a sensor device and a processor may generate an interrupt request (IRQ) pulse at a time determined in the clock domain of the processor if a real-time interrupt (RTI) pulse from the sensor device is not detected. On the other hand, if an RTI pulse is detected, an IRQ pulse may be generated at a first time-offset from the RTI pulse, which is based on the clock domain of the sensor device. The I/O interface may further establish, at a second time-offset from the IRQ pulse, a time span for monitoring a subsequent RTI pulse and concomitant sensor data, and thus check for the subsequent RTI pulse or the concomitant sensor data (either of which may not occur) within the time span. In some implementations, the interface may be an inertial measurement unit (IMU) interface and the processor may be an FPGA. The second time-offset is a time span for when the subsequent RTI pulse and the concomitant sensor data are prevented from being monitored or provided to a processor system.

The interface may further provide the IRQ pulse to the processor and may also provide the sensor data to the processor substantially when the processor system receives the IRQ pulse. If the subsequent RTI pulse or the concomitant sensor data are detected outside the time span, the subsequent RTI pulse and/or the concomitant sensor data may be disregarded or discarded.

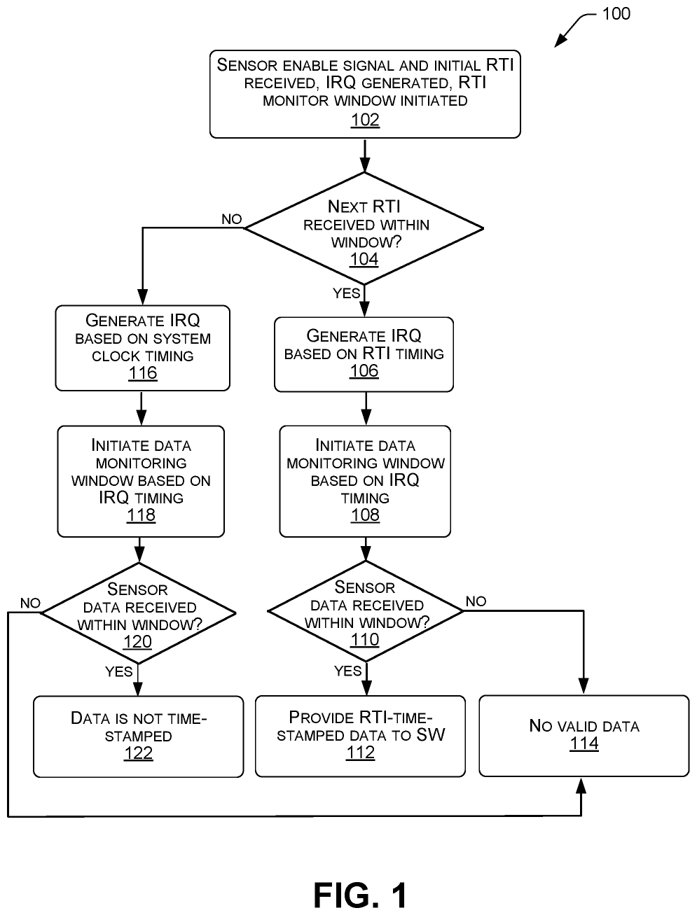

FIG. 1 is a flow diagram illustrating a data acquisition process 100 for a sensor-FPGA system having two clock domains, according to some embodiments. For example, one of the clock domains may be in an inertial measurement unit (IMU) while the other may be in a computer processor system. An interface may perform process 100 by handling sensor data processing, sensor power control, RTI generation for subsequent software processing (e.g., in processor system 3 404), and providing various status indicators to a software interface, among other things. In normal operation, the computer processor system may generate a periodic (e.g., 300 Hz) IRQ to initiate input (into the processor system) of sensor information, which comprises sensor measurement (SM) data and associated time information, based on the timing and quality of RTI/SM data input (into the interface) from the sensors. At 102, a first-time IRQ may be synchronized to the initial RTI and SM data after sensors (e.g., of an IMU) are powered on by a sensor enable signal. At 104, the interface is waiting for the next RTI and first SM data. Normally, RTI is promptly followed by SM data at the interface. In other words, RTI normally includes concomitant sensor measurement data. At 106, if the interface receives an RTI within a monitor window, the RTI will be timestamped based on the local time domain of the computer processor system and an IRQ will be generated. At 108, based on the timing of the IRQ, the interface will begin a data monitoring window during which sensor data (or other type of data) is ready to be received. At 110, if sensor data is received within the timeframe of the window, process 100 advances to 112, where the sensor data is timestamped based on the received RTI and then provided to software (SW) of the computer processing system. On the other hand, at 110, if sensor data is not received within the timeframe of the window, process 100 advances to 114, and no valid data is available for the software. Process 100 may then repeat beginning at 104.

Returning to 104 of process 100, if am RTI is not received within the window, process 100 advances to 116, where the interface generates an IRQ based on clock timing of the computer processor system (e.g., a regular clock signal at 300 Hz). At 118, the interface will begin a data monitoring window during which sensor data (or other type of data) is ready to be received. At 120, if sensor data is received within the timeframe of the window, process 100 advances to 122, where the sensor data is provided to SW of the computer processing system but not timestamped. On the other hand, at 110, if sensor data is not received within the timeframe of the window, process 100 advances to 114, and no valid data is available for the software. Process 100 may then repeat beginning at 104.

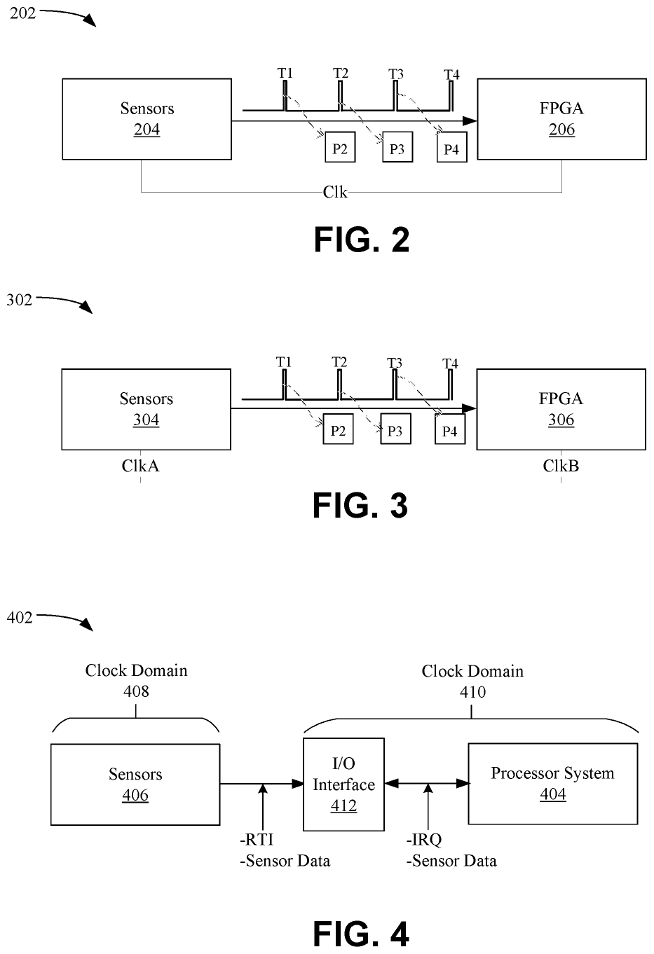

FIG. 2 is a block diagram illustrating a data acquisition process for a sensor-FPGA system 202 having a common clock domain (Clk), according to some embodiments. Sensors 204 (which may be a single sensor in some implementations) may be navigation sensors, such as an inertial measurement unit sensor (e.g., or any of position, velocity, acceleration sensors), GPS sensors, gyroscopic sensors, or proximity sensors, just to name a few examples. An FPGA 206 is used in examples herein, however, unless otherwise noted, an FPGA may be replaced by any of a number of types of computer processors.

Sensors 204 may output time information via various discrete signals, illustrated as T1, T2, T3, and T4, which are generated by clock Clk. In some implementations, clock Clk may be a clock for system 202 while in other implementations Clock Clk may be a clock for the FPGA. In the latter case, timing information from Clock Clk may be provided to sensors 204, thus allowing the sensors and FPGA to share timing information so as to be synchronized with each other. Accordingly, each discrete signal T1, T2, T3, and T4 may initiate a sequence of events that lead to a predicted window, P2, P3, P4, wherein availability of sensor data is monitored and timestamped for a navigation algorithm, for example, to use. Such a predicted window can filter unwanted data (e.g., involving glitches, noise, and so on). In other words, the discrete signals may be used to set up the timing for when FPGA 206 can expect to receive valid sensor data. Because Clock Clk is timing information that is shared between sensors 204 and FPGA 206, the timing of the discrete signals and availability of sensor data is well-defined.

FIG. 3 is a block diagram illustrating a data acquisition process for a sensor-FPGA system 302 having two clock domains, ClkA and ClkB, according to some embodiments. Sensors 304 may be similar to or the same as sensors 204. FPGA 306 may be similar to or the same as FPGA 206. Sensors 304 may output time information via various discrete signals, illustrated as T1, T2, T3, and T4, which are generated by clock ClkA. Since FPGA 306, in clock domain ClkB, and sensors 304, in clock domain ClkA, operate with different clock domains, predicted windows P1, P2, P3, and P4 for capturing the discrete signals may likely drift. Thus, eventually, sensor outputs will drift out of FPGA-defined data-capturing windows. Dynamically synchronized prediction windows, as discussed in example embodiments below, may be used to eliminate such accumulated clock drift between a sensor clock domain that is different from an FPGA clock domain.

FIG. 4 is a block diagram of a sensor-processor system 402, according to some embodiments. Sensor-processor system 402 may be similar to or the same as system 302. For example, processor system 404 may be an FPGA or computer processor with associated components (e.g., bus, memory, software, etc.). Sensors 406 operate in a clock domain 408 and processor system 404 operates in a clock domain 410. An input/output (I/O) interface 412 may share timing information with processor system 404 so that I/O interface 412 also operates in clock domain 410. Sensors 406 provide sensor data and timing information, such as real-time interrupt requests, hereinafter called RTIs, to processor system 404 via I/O interface 412. I/O interface 412 may timestamp and pass the sensor data to the processor system 404. Interrupt request signals, hereinafter called IRQs, may be generated by the I/O interface and provided to the processor system.

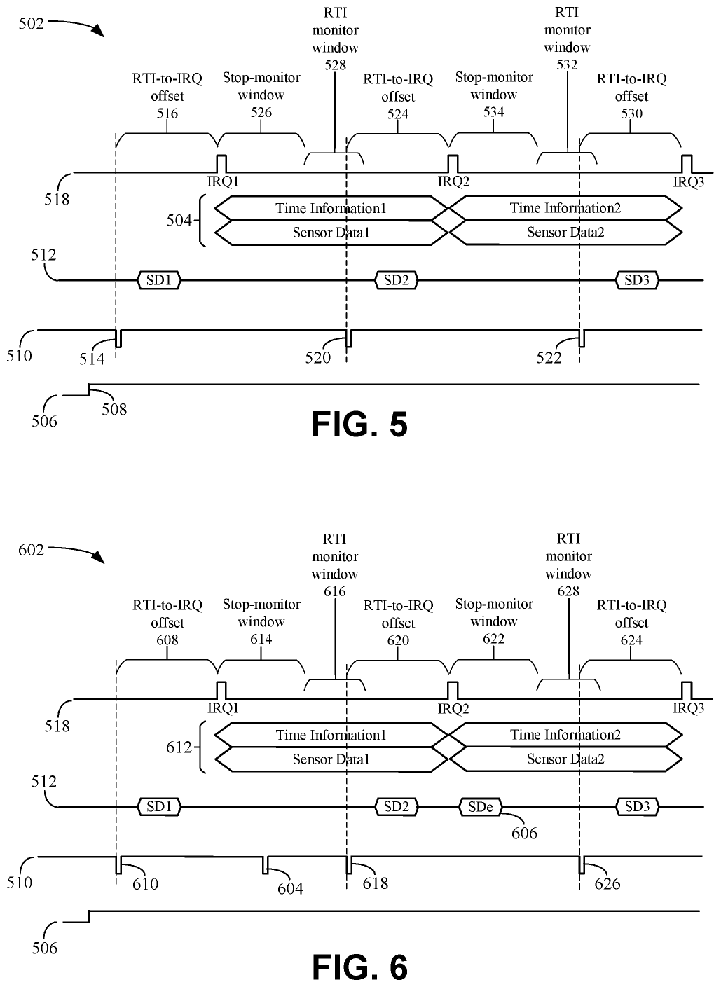

FIG. 5 is a timing diagram 502 for data acquisition, according to some embodiments. The data acquisition may be performed, as in the following examples, by a system such as sensor-processor system 402 of FIG. 4.

I/O interface 412, which may be an inertial measurement unit (IMU) interface, may handle sensor data processing, sensor power control, RTI generation for subsequent software processing (e.g., in processor system 404), and may provide various status indicators to a software interface. The data acquisition timing process illustrated in FIG. 5 may be performed by I/O interface 412. In normal operation, processor system 404 (which includes software SW) may generate a periodic (e.g., 300 Hz) IRQ to alert the processor system to initiate input (into the processor system) of sensor information 504, which comprises sensor measurement (SM) data and concomitant time information, based on the timing and quality of RTI/SM data input (into the I/O interface) from sensors 406. This may be a multi-step procedure, described below, involving first-time IRQ synchronization, steady state normal operation, and resynchronization, for example.

First-time IRQ may be synchronized to RTI and SM data after sensors 406 (e.g., an IMU) are powered on by a sensor enable signal 506, at 508. I/O interface 412 is waiting for the first RTI 514 and first SM data, (SD1). Line 510 is the timing of RTI and line 512 is the timing of SM data. Normally, RTI is promptly followed by SM data at the I/O interface. In other words, RTI normally includes concomitant sensor measurement data. Upon the falling edge of RTI 514 (assuming signal polarity is not inverted), the RTI will be timestamped based on the local time domain 410 of processor system 404. This RTI may be “qualified” (explained below) after a fixed time span 516, herein called “RTI-to-IRQ offset”, which is sized to include RTI-to-SM data serial input delay and SM data protocol processing times, as described in detail below. After the fixed RTI-to-IRQ offset 516, SM data may be examined with a cyclic redundancy check (CRC), and the first IRQ (IRQ1 as shown in timing line 518) will be generated for SW with an RTI timestamp and SM data. At this time, SM data (Sensor Data1) and Time Information1, which may be buffered in I/O interface 412, may be received by processor system 406.

A time span for blocking RTI and SM data, called the “stop-monitor window”, begins at each occurrence of an IRQ. For example, stop-monitor window 526 begins at or near the rising edge of IRQ1. During this time span, any RTI or SM data, which is not expected and likely faulty data or a glitch, will be blocked, ignored, or discarded. In contrast, at the end of stop-monitor window 526 is a time span, called an RTI monitor window 528, during which the arrival of an expected RTI is monitored. RTI monitor window 528 is centered at a point in time called a “predicted RTI time”, which is explained below.

Subsequent IRQs may be generated at times defined by subsequent RTIs. For example, RTI 520 leads to IRQ2 and RTI 522 leads to IRQ3. After the first-time IRQ synchronization, described above, processor system 404 may set up an internal timeout counter (e.g., 300 Hz) to predict the next RTI occurrence. After receiving such an RTI (e.g., 520) and valid SM data (e.g., SD2), I/O interface 412 may generate an IRQ2 with a fixed RTI-to-IRQ offset (e.g., 524) for normal operation. If, for some reason, an RTI is not received, I/O interface 412 may generate a subsequent IRQ based on the internal timeout counter instead of being based on an RTI (which doesn't exist in this cycle), as explained below.

I/O interface 412 or processor system 404 may provide a control register for SW to asynchronously enable the first-time synchronization mode, as described above. Asynchronous enablement may be used if SW detects a loss of (e.g., missing or timewise misplaced) RTI and/or SM data, perhaps resulting from a glitch or clock drift, for example. In this case, a “missing” RTI would fail to lead to generation of an IRQ, as in normal operation, described above. Without an RTI, a periodic (e.g., 300 Hz) IRQ could be generated by I/O interface 412, but a regular, cyclic occurrence of an IRQ will likely not be in sync with the availability of sensor data (with the correct timestamp). For example, using such an I/O interface-generated periodic IRQ for determining when to look for sensor data may result in missing incoming RTI/SM data that are not occurring in (e.g., not in sync with) an RTI monitor window. Thus, asynchronous enablement may be used, to force I/O interface 412 to re-sync IRQ to the RTI/SM data without a full power cycle of any part of system 402.

As mentioned above, an RTI-to-IRQ offset (e.g., 516, 524, and 530) is a fixed time span that is sized to include RTI-to-SM data serial input delay and SM data protocol processing times. In a particular numerical example, using 300 Hz as the frequency of the periodically generated IRQ, an RTI-to-IRQ offset may be about 1.2 milliseconds (msec) from RTI input to IRQ, wherein 1.2 msec contains the following time budget: 25 microseconds (usec) from RTI leading edge (for example, a falling edge when polarity is not altered) to SDLC data delay and 1.066 msec for sensor message (e.g., 100 bytes) transmission time. Thus, RTI and SDLC data should be completed within 1.1 msec in an unrealistic worst case, thus 1.2 msec may be selected to define the RTI-to-IRQ offset window. Such numbers are merely examples, and claimed subject matter is not so limited.

Introduced above, a “qualified” RTI transaction refers to a single RTI transaction (for example, a falling edge, assuming no altered polarity) followed by a CRC-correct SM data message, from RTI transaction to end of message, wherein the duration is within the RTI-to-IRQ offset after the transaction.

A predicted RTI time, as mentioned above, refers to a point in time that is a fixed time after an IRQ. In the current numerical example, the fixed time is given by [300 Hz period-1.2 msec-150 usec]. An RTI monitor window, such as 528 and 532, refers to a time span centered at the predicted RTI time. This time span may be 300 usec, for example. In some implementations, prior to occurrence of a predicted RTI, I/O interface 412 or processor system 404 may setup a window that is about 10% of RTI duration (e.g., total ˜300 usec with 150 usec before and after predicted next RTI occurrence). This window starts 150 usec before the predicted RTI and ends, at the most, 150 usec after the predicted RTI. If SM serial data is detected before 150 usec elapses after the predicted RTI, the current RTI monitor window will terminate before it reaches the +150 usec boundary.

The stop-monitor window, as described above, refers to a window from IRQ to the RTI monitor window (e.g., 300 Hz period-1.2 msec after IRQ). In this window, I/O interface 412 will stop monitoring incoming RTI and SM serial data, thus potentially filtering out unwanted possible glitches, as explained below is the following example embodiments. Again, such numbers are merely examples, and claimed subject matter is not so limited.

FIGS. 6-10 are timing diagrams for data acquisition for sensor-processor system 402 of FIG. 4, involving various example error conditions (e.g., glitches) based on sensor data, according to some embodiments. In these conditions, I/O interface 412 may use an established internal (e.g., 300 Hz) timer to generate continued (e.g., at 300 Hz) IRQs to wake up, or otherwise notify, the processor system. Accordingly, the status of time information and data information may be updated for each IRQ to reflect the current status. In contrast, FIG. 5 depicted normal (e.g., error-free sensor data) operation of the sensor-processor system 402 and used RTIs to determine times when IRQs are generated. In some examples, an error or “glitch” may be based on differences between the different time domains of the sensors and the processor system (e.g., non-synced). An example error condition is if sensors (e.g., an IMU) have data dropouts for either RTI or SM data, the I/O interface may not be able to detect the RTI or SM data.

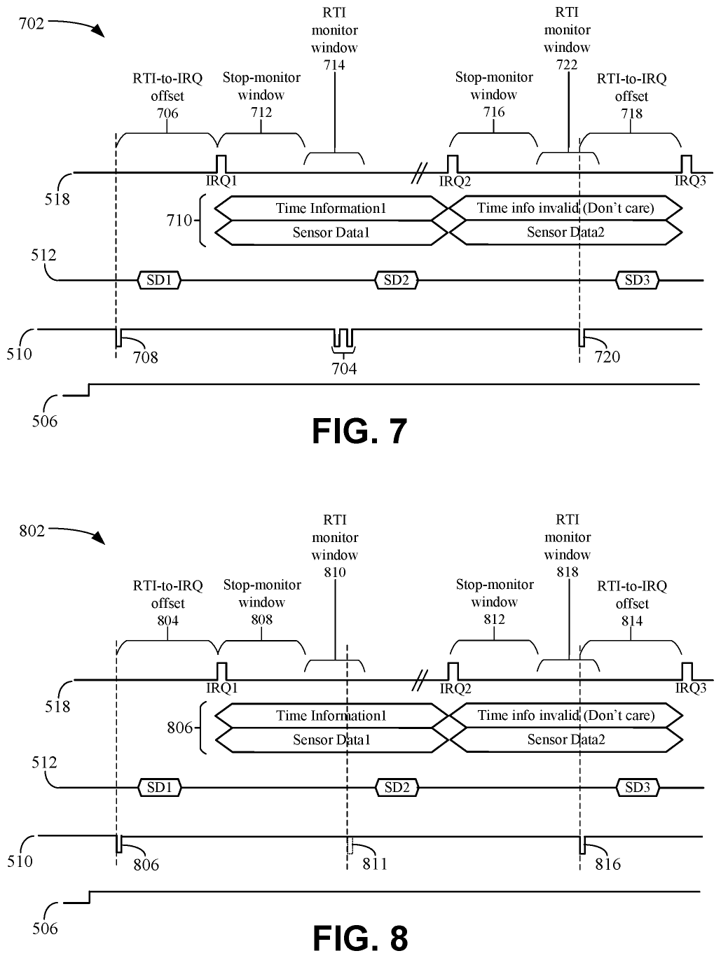

FIG. 6 is a timing diagram 602 that involves an extra RTI 604 and extra SD data 606. For example, for some reason sensors 406 may asynchronously output the extra RTI and SM data. As described below, the IRQs are generated based on occurrences of the RTIs. This is in contrast to some examples described for FIGS. 7-10, which involve IRQs that are generated based on a fixed frequency in clock domain 410. A sequence of events will now be described, assuming that sensors 406 have been previously (e.g., greater than several prior cycles) powered on by sensor enable signal 406.

An RTI-to-IRQ offset 608 starts upon detection of an RTI 610. An IRQ1 is generated at the conclusion of RTI-to-IRQ offset 608. Consequently, sensor data1 (SD1) and a timestamped RTI (e.g., 612) are provided for SW use. A stop-monitor window 614 begins at IRQ1. During this time span, extra (erroneous, asynchronous) RTI 604 occurs (without concomitant SM data). Because its occurrence is within stop-monitor window 614, RTI 604 is ignored.

An RTI monitor window 616 begins at the conclusion of stop-monitor window 614. Within RTI monitor window 616, an RTI 618 occurs. Accordingly, another RTI-to-IRQ offset 620 starts upon detection of RTI 618. An IRQ2 is generated at the conclusion of RTI-to-IRQ offset 620. Consequently, sensor data2 (SD2) and a timestamped RTI (e.g., 612) are provided for SW use. A stop-monitor window 622 begins at IRQ2. During this time span, extra (erroneous, asynchronous) SDe 606 occurs (without a concomitant RTI). Because its occurrence is within stop-monitor window 622, SDe 606 is ignored. Continuing to the next cycle, another RTI-to-IRQ offset 624 starts upon detection of an RTI 626 within RTI monitor window 628. An IRQ3 is generated at the conclusion of RTI-to-IRQ offset 624, and the sequence of events continue as described above.

FIG. 7 is a timing diagram 702 that involves a double occurrence of RTI 704 (or other type of noisy or misshapen RTI pulse), a glitch perhaps caused by a power or other anomaly. As a result, as described below, at least one IRQ will be generated based on a fixed frequency in clock domain 410 instead of being based on an occurrence of the RTIs. A sequence of events will now be described, assuming that sensors 406 have been previously (e.g., greater than several prior cycles) powered on by sensor enable signal 406.

An RTI-to-IRQ offset 706 starts upon detection of an RTI 708. An IRQ1 is generated at the conclusion of RTI-to-IRQ offset 706. Consequently, sensor data1 (SD1) and a timestamped RTI (e.g., 710) are provided for SW use. A stop-monitor window 712 begins at IRQ1. An RTI monitor window 714 begins at the conclusion of stop-monitor window 712. Within RTI monitor window 714, double RTI 704 occurs. Because of its faulty nature, RTI 704 is not qualified by the SW. Thus, the next IRQ will not be generated based on RTI 704. Instead, a free-running timer (e.g., 300 Hz) in clock domain 410 will determine the time of the subsequent IRQ generation. Accordingly, based on this timing, an IRQ2 is generated and sensor data2 (SD2) is provided for SW use. A timestamped RTI does not exist for this data acquisition cycle. A stop-monitor window 716 begins at IRQ2 and another RTI-to-IRQ offset 718 starts upon detection of an RTI 720 within RTI monitor window 722. An IRQ3 is generated at the conclusion of RTI-to-IRQ offset 718, and the sequence of events continue as described above.

FIG. 8 is a timing diagram 802 that involves a missing RTI, a glitch perhaps caused by a power or other anomaly. As a result, as described below, at least one IRQ will be generated based a fixed frequency in clock domain 410 instead of being based on an occurrence of an RTI. A sequence of events will now be described, assuming that sensors 406 have been previously (e.g., greater than several prior cycles) powered on by sensor enable signal 406.

An RTI-to-IRQ offset 804 starts upon detection of an RTI 806. An IRQ1 is generated at the conclusion of RTI-to-IRQ offset 804. Consequently, sensor data1 (SD1) and a timestamped RTI (e.g., 806) are provided for SW use. A stop-monitor window 808 begins at IRQ1. An RTI monitor window 810, which begins at the conclusion of stop-monitor window 808, concludes without detection of an RTI. For example, a “possible” RTI 811, illustrated for explanatory purposes, may occur but does not in this example. Thus, the next IRQ will not be generated based on an RTI (which doesn't exist). Instead, a free-running timer (e.g., 300 Hz) in clock domain 410 will determine the time of the subsequent IRQ generation. Accordingly, based on this timing, an IRQ2 is generated and sensor data2 (SD2) is provided for SW use. A timestamped RTI does not exist for this data acquisition cycle. A stop-monitor window 812 begins at IRQ2 and another RTI-to-IRQ offset 814 starts upon detection of an RTI 816 within RTI monitor window 818. An IRQ3 is generated at the conclusion of RTI-to-IRQ offset 814, and the sequence of events continue as described above.

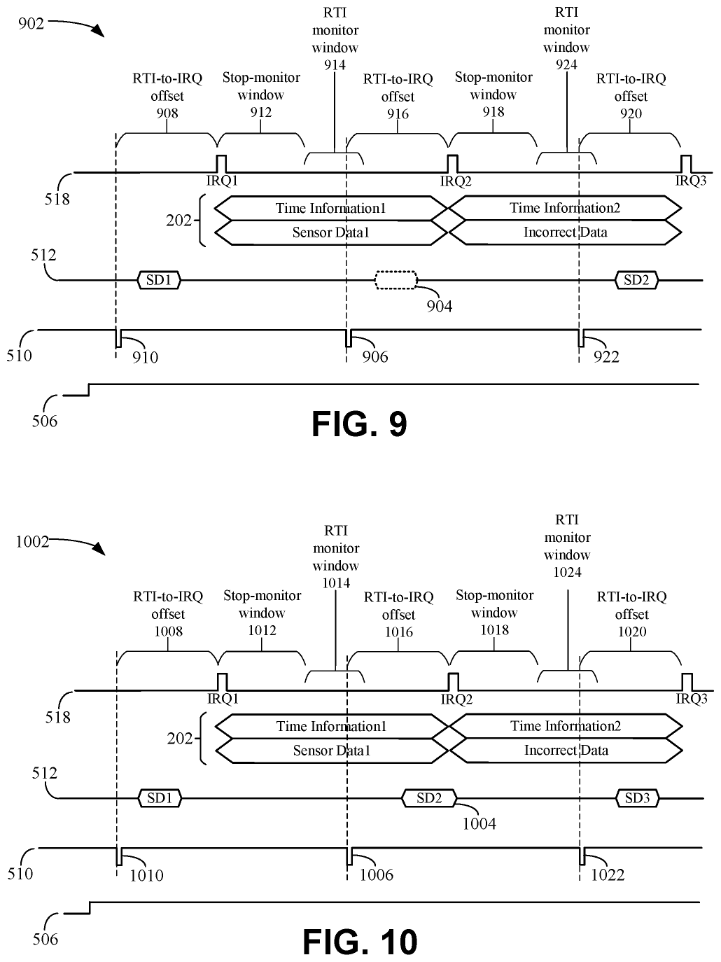

FIG. 9 is a timing diagram 902 that involves missing SD data 904, which should otherwise accompany an RTI 906. For example, for some reason sensors 406 may fail to perform a measurement in a particular cycle or SM data may be lost for some reason. Because all RTIs are present in this example (e.g., the glitch involves data, not the RTIs), the IRQs are generated based on occurrences of the RTIs. A sequence of events will now be described, assuming that sensors 406 have been previously (e.g., greater than several prior cycles) powered on by sensor enable signal 406.

An RTI-to-IRQ offset 908 starts upon detection of an RTI 910. An IRQ1 is generated at the conclusion of RTI-to-IRQ offset 908. Consequently, sensor data1 (SD1) and a timestamped RTI (e.g., 910) are provided for SW use. A stop-monitor window 912 begins at IRQ1. An RTI monitor window 914 begins at the conclusion of stop-monitor window 912. Within RTI monitor window 914, RTI 906 occurs. Accordingly, another RTI-to-IRQ offset 916 starts upon detection of RTI 906. An IRQ2 is generated at the conclusion of RTI-to-IRQ offset 916. Normally, SM data and a timestamped RTI (e.g., 906) are provided for SW use. However, SM data does not exist, or at least was not detected outside stop-monitor window 912. Accordingly, the timestamped RTI sans valid data is provided for SW use. Next, a stop-monitor window 918 begins at IRQ2. Continuing to the next cycle, another RTI-to-IRQ offset 920 starts upon detection of an RTI 922 within RTI monitor window 924. An IRQ3 is generated at the conclusion of RTI-to-IRQ offset 920, and the sequence of events continue as described above.

FIG. 10 is a timing diagram 1002 that involves asynchronous SM data 1004, which accompanies an RTI 1006. For example, delivery or availability of SM data may be delayed for some reason. Because all RTIs are present in this example (e.g., the glitch involves data, not the RTIs), the IRQs are generated based on occurrences of the RTIs. A sequence of events will now be described, assuming that sensors 406 have been previously (e.g., greater than several prior cycles) powered on by sensor enable signal 406.

An RTI-to-IRQ offset 1008 starts upon detection of an RTI 1010. An IRQ1 is generated at the conclusion of RTI-to-IRQ offset 1008. Consequently, sensor data1 (SD1) and a timestamped RTI (e.g., 1010) are provided for SW use. A stop-monitor window 1012 begins at IRQ1. An RTI monitor window 1014 begins at the conclusion of stop-monitor window 1012. Within RTI monitor window 1014, RTI 1006 occurs. Accordingly, another RTI-to-IRQ offset 1016 starts upon detection of RTI 1006. An IRQ2 is generated at the conclusion of RTI-to-IRQ offset 1016. Normally, SM data 1004 and a timestamped RTI (e.g., 1006) are provided for SW use. However, SM data 1004 is not completely received within RTI-to-IRQ offset 1016. Accordingly, the timestamped RTI sans valid data is provided for SW use. Next, a stop-monitor window 1018 begins at IRQ2. Continuing to the next cycle, another RTI-to-IRQ offset 1020 starts upon detection of an RTI 1022 within RTI monitor window 1024. An IRQ3 is generated at the conclusion of RTI-to-IRQ offset 1020, and the sequence of events continue as described above.

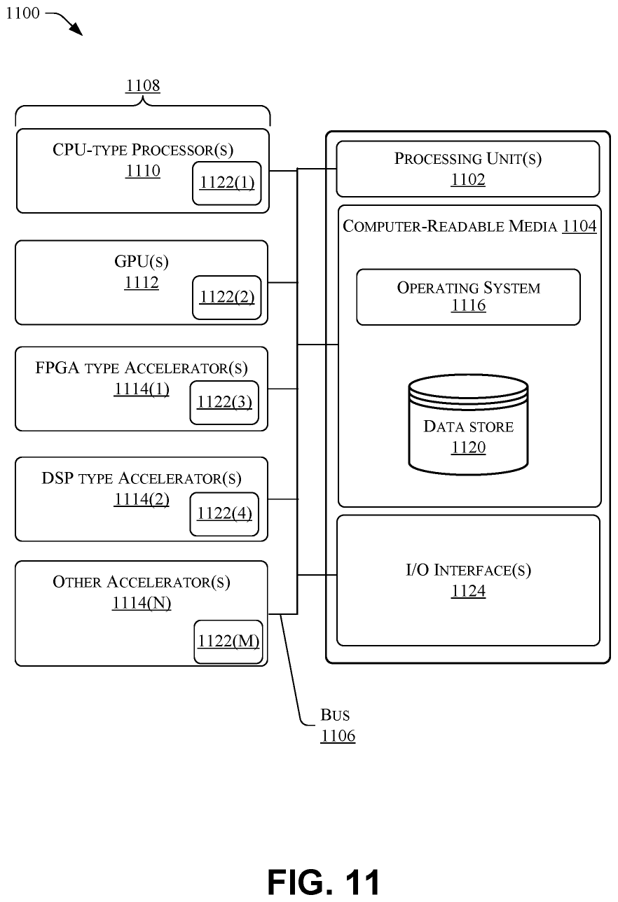

FIG. 11 is a block diagram of a processor system 1100, according to some embodiments. System 1100 may include any type of computing device having one or more processing unit(s) 1102 operably connected to computer-readable media 1104, which may include software SW that performs some of the functions described in example embodiments above. The connection may be via a bus 1106, which in some instances may include one or more of a system bus, a data bus, an address bus, a PCI bus, a Mini-PCI bus, and any variety of local, peripheral, and/or independent buses, or via another operable connection. Processing unit(s) 1102 may represent, for example, a CPU incorporated in system 1100. The processing unit(s) 1102 may similarly be operably connected to computer-readable media 1104.

The computer-readable media 1104 may include volatile and non-volatile machine-readable, removable, and non-removable media implemented in any method or technology for storage of information (in compressed or uncompressed form), such as computer (or other electronic device) readable instructions, data structures, program modules, or other data to perform processes or methods described herein. Computer storage media include, but are not limited to hard drives, floppy diskettes, optical disks, CD-ROMs, DVDs, Blu-ray, read-only memories (ROMs), random access memories (RAMs), EPROMs, EEPROMs, flash memory, magnetic or optical cards, solid-state memory devices, or other types of media/machine-readable medium suitable for storing electronic instructions.

System 1100 may include, but is not limited to, desktop computers, server computers, web-server computers, personal computers, smartphones, mobile computers, laptop computers, tablet computers, wearable computers, implanted computing devices, telecommunication devices, space vehicle computers, thin clients, terminals, integrated components for inclusion in a computing device, appliances, or any other sort of computing device such as one or more separate processor device(s) 1108, such as CPU-type processors (e.g., micro-processors) 1110, GPUs 1112, or accelerator device(s) 1114.

In some examples, as shown regarding system 1100, computer-readable media 1104 may store instructions executable by the processing unit(s) 1102, which may represent a CPU incorporated in system 1100. Computer-readable media 1104 may also store instructions executable by an external CPU-type processor 1110, executable by a GPU 1112, and/or executable by an accelerator 1114, such as an FPGA type accelerator 1114(1), a DSP type accelerator 1114(2), or any internal or external accelerator 1114(N).

Executable instructions stored on computer-readable media 1104 may include, for example, an operating system 1116 and other modules, programs, or applications that may be loadable and executable by processing units(s) 1102, and/or 1110. Alternatively, or in addition, the functionally described herein may be performed by one or more hardware logic components such as accelerators 1114. For example, and without limitation, illustrative types of hardware logic components that may be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. For example, accelerator 1114(N) may represent a hybrid device, such as one that includes a CPU core embedded in an FPGA fabric.

In the illustrated example, computer-readable media 1104 also includes a data store 1120. In some examples, data store 1120 includes data storage such as a database, data warehouse, or other type of structured or unstructured data storage. In some examples, data store 1120 includes sensor data with associated timestamp information. Data store 1120 may store data for the operations of processes, applications, components, and/or modules stored in computer-readable media 1104 and/or executed by processor(s) 1102 and/or 1110, and/or accelerator(s) 1114. Alternately, some or all of the above-referenced data may be stored on separate memories 1122 such as a memory 1122(1) onboard CPU type processor 1110 (e.g., microprocessor(s)), memory 1122(2) onboard GPU 1112, memory 1122(3) onboard FPGA type accelerator 1114(1), memory 1122(4) onboard DSP type accelerator 1114(2), and/or memory 1122(M) onboard another accelerator 1114(N).

System 1100 may further include one or more input/output (I/O) interface(s) 1124, such as I/O interface 412, to allow system 1100 to communicate with input/output devices such as sensors (e.g., navigational sensors or an IMU) or user input devices including peripheral input devices (e.g., a keyboard, a mouse, a pen, a voice input device, a touch input device, a gestural input device, and the like) and/or output devices including peripheral output devices (e.g., a display, a printer, audio speakers, a haptic output, and the like).

Although the subject matter has been described in language specific to structural features and/or methodological acts, it is to be understood that the subject matter defined in the appended claims is not necessarily limited to the specific features or acts described. Rather, the specific features and steps are disclosed as example forms of implementing the claims.

All of the methods and processes described above may be embodied in, and fully automated via, software code modules executed by one or more general purpose computers or processors. The code modules may be stored in any type of computer-readable medium, computer storage medium, or other computer storage device. Some or all of the methods may alternatively be embodied in specialized computer hardware.

Conditional language such as, among others, “can,” “could,” “may” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments or examples are presented by way of examples for purposes of illustration and description. They are not intended to be exhaustive of or to limit this disclosure to the precise forms described. Many modifications and variations are possible in view of the above teachings. The embodiments or examples are shown and described in order to best explain the principles of this disclosure and practical applications, to thereby enable others skilled in the art to best utilize this disclosure and various embodiments or examples with various modifications as are suited to the particular use contemplated. It is intended that the scope of this disclosure be defined by the following claims and their equivalents.

We claim as follows:

1. A method comprising:
generating (i) an interrupt request (IRQ) pulse at a time determined in a first clock domain when a real-time interrupt (RTI) pulse is not detected, and (ii) an IRQ pulse at a first time-offset from the RTI pulse when the RTI pulse is detected, wherein the RTI pulse is based on a second clock domain;
establishing, at a second time-offset from the IRQ pulse, a time span for monitoring a subsequent RTI pulse and concomitant sensor data; and
checking for the subsequent RTI pulse or the concomitant sensor data within the time span.

2. The method of claim 1, wherein the method is performed by an input/output (I/O) interface.

3. The method of claim 2, wherein the I/O interface is an inertial measurement unit interface.

4. The method of claim 1, wherein the second clock domain is in a sensor device.

5. The method of claim 4, wherein the first clock domain is in a processor system configured to receive the IRQ pulse.

6. The method of claim 5, wherein the processor system is a field programmable gate array (FPGA).

7. The method of claim 1, wherein the time determined in the first clock domain is based on a system clock having a fixed frequency.

8. The method of claim 1, wherein the second time-offset is a time span for when the subsequent RTI pulse and the concomitant sensor data are prevented from being monitored or provided to a processor system.

9. The method of claim 1, further comprising providing the IRQ pulse to a processor system and providing the sensor data to the processor system substantially when the processor system receives the IRQ pulse.

10. The method of claim 1, further comprising:
responsive to detecting the subsequent RTI pulse or the concomitant sensor data outside the time span, discarding at least one of the following: (i) the subsequent RTI pulse, and (ii) the concomitant sensor data.

11. The method of claim 1, further comprising transferring the concomitant sensor data into a buffer within the first time-offset.

12. The method of claim 1, wherein the first time-offset, the second time-offset, and the time span for monitoring the subsequent RTI pulse and the concomitant sensor data occur sequentially occur between consecutive IRQ pulses.

13. A system comprising a processor and a memory, the memory storing instructions that, when executed by the processor, cause the processor to:
generate an interrupt request (IRQ) pulse at a time determined in a first clock domain when a real-time interrupt (RTI) pulse is not detected, and, when the RTI pulse is detected, at a first time-offset from the RTI pulse, wherein the RTI pulse is based on a second clock domain;
establish, at a second time-offset from the IRQ pulse, a time span for monitoring a subsequent RTI pulse and concomitant sensor data; and
check for the subsequent RTI pulse or the concomitant sensor data within the time span.

14. The system of claim 13, wherein the first clock domain includes the processor, which is configured to receive the IRQ pulse.

15. The system of claim 14, wherein the processor is a field programmable gate array (FPGA).

16. The system of claim 13, wherein the time determined in the first clock domain is based on a system clock having a fixed frequency.

17. The system of claim 13, the memory storing further instructions that, when executed by the processor, cause the processor to receive the IRQ pulse and to receive the sensor data substantially when the processor receives the IRQ pulse.

18. The system of claim 13, the memory storing further instructions that, when executed by the processor, cause the processor to discard at least one of (i) the subsequent RTI pulse and (ii) the concomitant sensor data in response to detecting the subsequent RTI pulse or the concomitant sensor data outside the time span.

19. The system of claim 13, the memory storing further instructions that, when executed by the processor, cause the processor to transfer the concomitant sensor data into a buffer within the first time-offset.

20. The system of claim 13, wherein the first time-offset, the second time-offset, and the time span for monitoring the subsequent RTI pulse and the concomitant sensor data occur sequentially occur between consecutive IRQ pulses.
